(19) United States
(12) Patent Application Publication
(10) Pub. No.: US 2019/0186356 A1
(43) Pub. Date: Jun. 20, 2019

(54) SEGMENTED THERMAL BARRIERS FOR INTERNAL COMBUSTION ENGINES AND METHODS OF MAKING THE SAME

(71) Applicant: CORNING INCORPORATED, CORNING, NY (US)

(72) Inventors: Dana Craig Bookbinder, Corning, NY (US); Roy Joseph Bourcier, Corning, NY (US); William Edward Lock, Horseheads, NY (US); Richard Curwood Peterson, Elmira Heights, NY (US); Irene Marjorie Slater, Lindley, NY (US); Pushkar Tandon, Painted Post, NY (US)

(21) Appl. No.: 16/327,933

(22) PCT Filed: Aug. 25, 2017
(86) PCT No.: PCT/US2017/048578

§ 371 Date: Feb. 25, 2019

Related U.S. Application Data
(60) Provisional application No. 62/379,422, filed on Aug. 25, 2016.

(51) Int. Cl. F02B 77/11; F16L 59/02; F16L 59/07; F16L 59/12

(52) U.S. Cl. CPC F02B 77/11; F16L 59/123; F16L 59/07; F16L 59/028

(57) ABSTRACT

A segmented thermal barrier for a combustion chamber surface of an internal combustion engine. The segmented thermal barrier includes a plurality of modules, each module with a support and a shield. The edges of shields of at least two adjacent modules are spaced apart by a distance.

This application claims the benefit of priority under 35 U.S.C. § 119 of U.S. Provisional Application Serial No. 62/379,422 filed on Aug. 25, 2016, the content of which is relied upon and incorporated herein by reference in its entirety.

### BACKGROUND

### Field

The present disclosure relates generally to segmented thermal barriers for internal combustion engines.

### Technical Background

The efficiency of internal combustion engines may be improved by retaining heat from ignited fuel in the combustion chamber. This can be accomplished by minimizing heat loss to the surrounding engine. One solution has been to insulate parts of the combustion chamber. A problem with insulating the combustion chamber from the surrounding engine may be the development of strain within the thermal barrier during temperature cycling of the engine.

Accordingly, a need exists for improved thermal barriers within internal combustion engines.

### SUMMARY

According to an embodiment of the present disclosure, a thermal barrier is disclosed. In embodiments, the thermal barrier comprises an array of module each comprising at least one support and a shield. In embodiments, the shield edges of at least two modules in the module array are spaced apart by a distance when at room temperature.

According to an embodiment of the present disclosure, a method of making a thermal barrier is disclosed. In embodiments, making the thermal barrier comprises forming at least two modules for the module array.

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

### BRIEF DESCRIPTION OF THE DRAWINGS

The disclosure will be better understood, and features, aspects and advantages other than those set forth above will become apparent when consideration is given to the following Detailed Description thereof. Such Detailed Description makes reference to the following Figures.

FIG. 1 is a cross-sectional view of a combustion chamber in an engine during an intake stroke according to an exemplary embodiment.

FIG. 2 is a cross-sectional view of the combustion chamber in the engine of FIG. 1 during an exhaust stroke according to an exemplary embodiment.

FIG. 3 is a plot of change in brake thermal efficiency (%) of an internal combustion engine at cruise operating conditions vs. piston thermal conductivity at 400° C. (W/m·° C.).

FIG. 4 is a perspective view of a thermal barrier on a surface within a combustion chamber of an engine according to exemplary embodiments.

FIG. 5 is a perspective, cross-sectional view of the thermal barrier in FIG. 4 on a piston surface of an engine according to exemplary embodiments.

FIG. 6 is a perspective view of a thermal barrier on a surface within a combustion chamber of an engine according to exemplary embodiments.

FIG. 7 is an overhead view of the thermal barrier in FIG. 6 on a surface within a combustion chamber of an engine according to exemplary embodiments.

FIG. 8 is a circular cross-section, perspective view of an individual module with a support including a hollow portion on a surface within a combustion chamber of an engine according to exemplary embodiments.

FIGS. 9A-C are perspective views of a thermal barrier according to exemplary embodiments.

FIG. 10 is a perspective view of two modules in the array as shown in FIGS. 9B and 9C according to exemplary embodiments.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary methods and materials are described below.

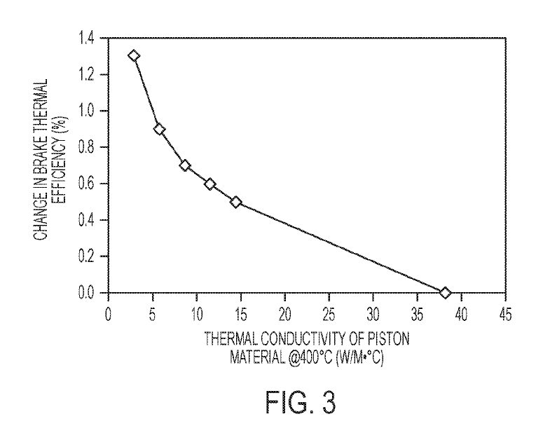

Engine fuel efficiency is affected by the thermal conductivity of the materials used to make the various components of an engine. This is particularly true for components within the combustion chamber of an engine (e.g., wall of the combustion chamber, pistons, valves, exhaust ports, manifolds, etc.). The higher the thermal conductivity of materials used in the combustion chamber, the more combustion energy lost to heat energy. By lowering the thermal conductivity of materials directly exposed to the combustion reaction, more energy of combustion is available for performing work and powering the engine (i.e., to drive the piston). That is, heat of combustion that is not lost to heat energy can be used to drive a turbocharger in the exhaust manifold and/or more effectively light off the catalytic converter during a cold-start of the engine. In addition, lowering the thermal conductivity of materials directly exposed to the combustion reaction may reduce the heat load on the engine's cooling system and thereby potentially improve aerodynamics of the vehicle with less air being diverted from outside the vehicle for the cooling system. Accordingly, the overall efficiency of the vehicle and engine (including fuel efficiency) may be improved with thermally resistant materials. FIG. 3 provides a plot of change in brake thermal efficiency (%) of an internal combustion engine at cruise operating conditions vs. the piston material's thermal conductivity at 400° C. (W/m·° C.). FIG. 3 illustrates the effect of piston material thermal conductivity on brake thermal efficiency of an engine at cruise operating conditions. The trend of FIG. 3 evidences that the increase in efficiency of an engine at cruise conditions may improve exponentially or in a nonlinear fashion by reducing the thermal conductivity of materials (for the appropriate temperature range) used within the combustion chamber.

Conventional methods for lowering the thermal conductivity of materials within the combustion chamber have included the use of thermal barriers. Conventional thermal barriers for combustion chambers of internal combustion engines may have one or more of several problems. One major shortcoming for conventional thermal barriers may be that the thermal barrier spalls or separates from the surface within the combustion chamber when exposed to the violent combustion kinetics, high pressures (e.g., 10 bars-500 bars), and high gas temperatures (e.g., 1000° C.-3000° C.) therein. Spalling of thermal barriers including brittle ceramic materials into the combustion chamber can cause damage (e.g., gouge, plug, etc.) to other engine components and the catalytic convertor. Another shortcoming of conventional thermal barriers may be insufficient thermal resistivity properties or a different coefficient of thermal expansion (CTE) than the combustion chamber surface which may lead to separation at high temperatures. Yet another shortcoming may be non-uniform thicknesses of conventional thermal barriers on engine component surfaces. Another short coming of conventional thermal barriers may be the development of mechanical strain within surfaces of the thermal barrier exposed to temperature cycling within a combustion chamber during engine operation. In conventional thermal barriers, thermal strain is sometimes managed by using low CTE coatings or compositional gradients through the coating thickness. These measures, however, constrain the materials available for use as a thermal barrier.

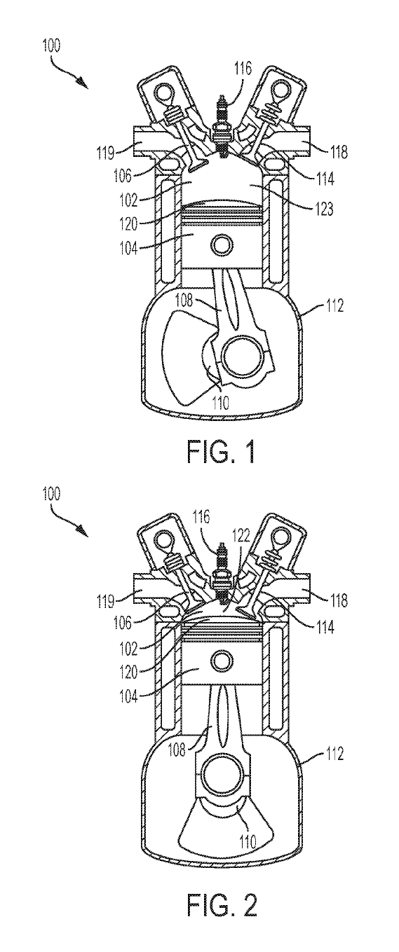

The present application is directed to a thermal barrier 200 on any metallic surface within an internal combustion engine 100. FIG. 1 provides a cross-sectional view of example engine 100 during an intake stroke. FIG. 2 provides another cross-sectional view of example engine 100 with piston 104 in a full-exhaust stroke position. Engine 100 of the present disclosure may be gasoline, diesel, natural gas, propane, or any other liquid or gas hydrocarbon powered internal combustion engine including any number (e.g., 1, 2, 3, 4, 5, 6, . . . , 12, . . . ) of combustion chambers. Engine 100 includes a number of components including a combustion chamber 102 with a piston 104 therein. Piston 104 is connected to a crankshaft 110 by a connecting rod 108 within a crankcase 112 of engine 100. Piston 104 includes a top surface 120 adjacent combustion chamber 102. Piston top surface may be flat, bowled, domed, or any combination thereof. Piston 104 may be made from carbon steel, aluminum, or other metals typically used in automotive applications. An intake valve 106, an intake duct 119, an exhaust valve 114, an exhaust duct 118, and a spark/glow plug 116 are also adjacent combustion chamber 102. Of course other components and configurations of engine 100 are possible and are in accordance with the present disclosure.

In FIG. 2, intake valve 106 is closed and exhaust valve 114 is open (when piston 104 is at a full-exhaust stroke position) connecting exhaust duct 118 with combustion chamber 102 and thereby forming a chamber exhaust volume 122. Chamber exhaust volume 122 is defined by wall surfaces and end surfaces of combustion chamber 102, a surface of intake valve 106, a surface of exhaust valve 114, top surface 120 of piston 104, and walls of exhaust duct 118 (which may include a turbocharger). In another embodiment, intake valve 106 and exhaust valve 114 are closed (when piston 104 is at a full-compression stroke position) thereby forming a chamber compression volume 121 (not shown). Chamber compression volume 121 is defined by walls and top surfaces of combustion chamber 102, a surface of intake valve 106, a surface of exhaust valve 114, and top surface 120 of piston 104. In yet another embodiment, intake valve 106 is open and exhaust valve 114 is closed (when piston 104 is at a full-intake stroke position) connecting intake duct 119 with combustion chamber 102 and thereby forming a chamber intake volume 123. Chamber intake volume 123 is defined by wall surfaces and end surfaces of combustion chamber 102, a surface of intake valve 106, a surface of exhaust valve 114, top surface 120 of piston 104, and walls of intake duct 119.

Thermal barrier 200 of the present disclosure may be on any metallic surface within engine 100. In an exemplary embodiment, thermal barrier 200 is on a metallic surface 101 within combustion chamber 102. Metallic surface 101 may be surfaces defining compression exhaust volume 121, surfaces defining chamber exhaust volume 122, or surfaces defining chamber intake volume 123. In one embodiment, surface 101 may not be wall surfaces of combustion chamber 102 contacted by piston 104. That is, thermal barrier 200 may be excluded from surfaces in chamber 102 subjected to mechanical friction from piston 104 or areas along the crevice quench that may wear or separate thermal barrier 200 from that surface. In another exemplary embodiment, metallic surface 101 is piston top surface 120, wall surfaces and end surfaces of combustion chamber 102, a surface of intake valve 106, a surface of exhaust valve 114, walls of exhaust duct 118, or walls of intake duct 119.

Thermal barrier 200 of the present disclosure includes an array of modules 201. The array of modules 201 (also called “module array” herein) may include any number of modules 201 greater than 1 module. In embodiments, each module 201 in the array includes a support 202 and a shield 206. The overall length and width of thermal barrier 200 including the array of modules 201 can have any suitable lateral dimensions (e.g., from about 0.1 mm to about 100 cm), including substantially equal dimensions. In embodiments, thermal barrier 200 includes lateral dimensions substantially equivalent to the applicable surface 101 within combustion chamber 102. In embodiments, thermal barrier 200 conforms substantially to the 2-dimensional and/or 3-dimensional contours of metallic surface 101. That is, the shape of thermal barrier 200 may conform to the rounded or non-uniform shapes of surface 101 to which it is connected, including a curved piston top surface 120.

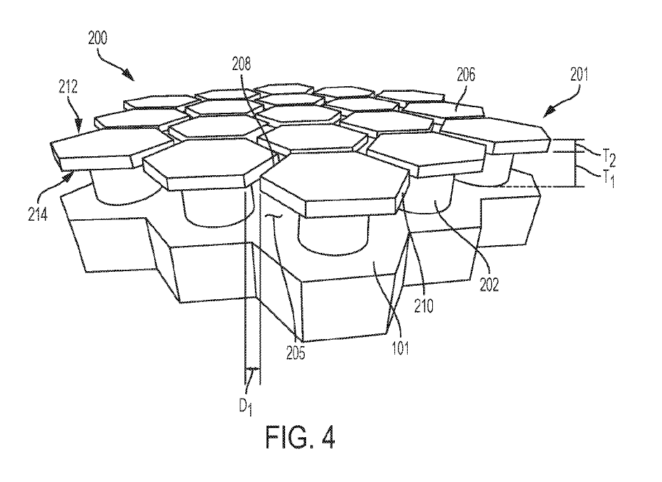

FIG. 4 provides an exemplary embodiment of thermal barrier 200 on surface 101. Support 202 includes a body with a first end opposite a second end, thereby defining a thickness T1. In embodiments, the first end or second end of support 202 joins directly or indirectly with surface 101. Support 202 and surface 101 may be joined by metallic bonding, metal-to-metal bonding, or direct mechanical attachment. The connection between support 202 and surface 101 is configured to resist the combustion temperatures and pressures within combustion chamber 102 during operation of engine 100. For example, support 202 may resist spalling from surface 101 for ≥100,000 miles inside operating engine 100. Support 202 may be applied to surface 101 via 3-D printing, metallic plating, welding (arc, laser, plasma, or friction), brazing, plasma spraying, mechanical fastening, or other conventional methods of creating metallic bonding or metal-to-metal bonds. Thickness T1 of support 202 may be distinct from a thickness of material comprising surface 101 by the presence of a vacant volume 205. Surface 101 within combustion chamber 102 may be identified from supports 202 by a lack of vacant volume 205. Alternatively or additionally, an interface at the joining of support 202 and surface 101 (caused by the bonding method) may help define thickness T1.

In embodiments, the first end or second end of support 202 (opposite the end joining surface 101) joins with a portion of at least one shield 206. Each support 202 has a height or thickness T1 between its opposite ends, as well as a width (or diameter). Support 202 may have any cross-sectional shape including rectangular, annular, hexagonal, and/or any other polygon shape. Each support 202 may have a circular cross-section as shown in FIG. 4. Thickness T1 of each support 202 may be from about 0.01 mm to about 10 mm, or from about 0.1 mm to about 2 mm, or from about 0.4 mm to about 2 mm, or even from about 0.5 mm to about 1 mm. In exemplary embodiments, thickness T1 of each support 202 is substantially uniform (e.g., +/−0.5 mm) across the length and the width of thermal barrier 200 including the array of modules 201. Thickness T1 of support 202 may be measured from surface 101 to a termination point (or end) of support 202 away from surface 101 (e.g., where support 202 joins directly or indirectly with shield 206).

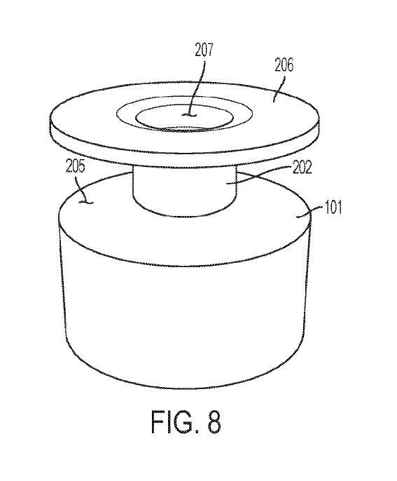

Support 202 may be substantially solid or porous across thickness T1. In embodiments where support 202 is porous, the porosity of support 202 may be from about 1% to about 99%, or from about 5% to about 90%. Support 202 may also include a porosity gradient across thickness T1. In embodiments, at least one support 202 in the module array includes a hollow portion 207 therein. In another embodiment, at least one support 202 in the module array is hollow across its thickness T1, defined by substantially solid side walls. FIG. 8 provides an example cross-sectional embodiment of a single module with a hollow portion 207. The structures of supports 202 in thermal barrier 200 are configured to retain their shape on surface 101 and around a vacant volume 205. In embodiments, the structure of support 202 is also capable of containing insulation material 204 within a vacant volume 205. The structure of support 202 may be sufficiently rigid and has thermo mechanical fatigue resistance so as to withstand the combustion temperatures and pressures within combustion chamber 102 during operation of engine 100.

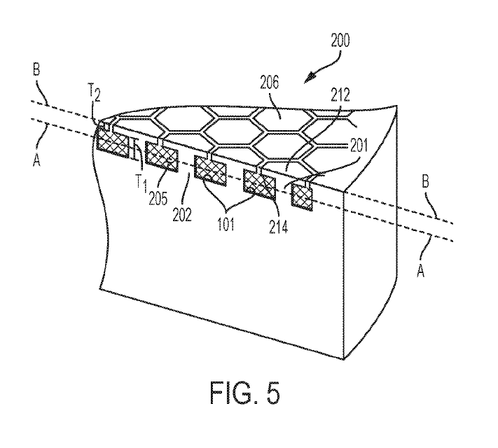

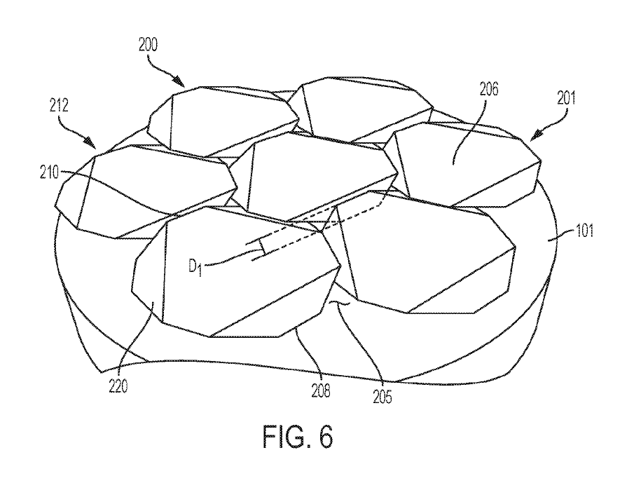

As shown in FIG. 4, each shield 206 in the module array includes first and second opposite edges 208, 210. Each shield 206 in the module array includes an upper portion 212 opposite a lower portion 214. Each shield 206 in the module array may be hexagonal (as shown in FIG. 5 along plane B-B), square, triangular, heptagonal, circular, annular, and combinations thereof. Of course other polygon shapes are in accordance with the present disclosure. In embodiments, thickness T2 of each shield 206 is defined between upper portion 212 and lower portion 214. In embodiments, shield 206 is substantially solid between upper portion 212 and lower portion 214. Thickness T2 of shield 206 may be from about 0.001 mm to about 5 mm, or from about 0.1 mm to about 2 mm, or even from about 0.1 mm to about 1 mm. In addition to thickness T2, each shield 206 also includes a length and a width. In embodiments, thickness T2 is substantially uniform across the length and the width of shield 206. As shown in FIG. 4, thickness T2 of shield 206 may be measured from the end of support 202 joined to lower portion 214 of shield 206. Shield 206 may be identified from support 202 by a joining interface, or by shield 206 having a larger cross-sectional area than support 202 in module 201. Upper portion 212 of each shield 206 may be configured for direct exposure to the combustion reaction (and associated temperatures and pressures) in combustion chamber 102. In embodiments, upper portion 212 of each shield 206 may have a variation tolerance along its surface in compliance with tolerances required for engine 100, such as ≤1 mm, or ≤0.01 mm. In embodiments, lower portion 214 of each shield 206 is spaced apart from and substantially parallel to surface 101.

Conventional thermal barriers may create a nonlinear temperature gradient between the combustion chamber surface on which the thermal barrier is attached and other adjacent surfaces which may be cooled by engine coolant. In one example, when a supported shield (or skin) is fixed to a surface of an internal combustion chamber, thermal expansion and contraction of the thermal barrier causes strain within the shield in areas between the supports. That is, in conventional thermal barriers, discrete portions of the skin are fixed to the combustion chamber surface by supports and areas of the shield (or skin) between the supports experience thermomechanical fatigue from expansion and contraction of the thermal barrier during temperature cycling in the combustion chamber. During heating, the continuous shield experiences compression in areas between the supports. During cooling, the continuous shield experiences tension in areas between the supports. This repeated process via temperature cycling in the combustion chamber can cause thermomechanical fatigue and failure.

Thermal barrier 200 of the present disclosure reduces thermal strains and thermomechanical fatigue in areas between supports 202 by providing breaks or segmentation between adjacent supports. That is, the shield 206 edges 208 or 210 of at least two modules in the array are spaced apart (either overlapping or non-overlapping) by a distance D1 when at room temperature. That is, edges 208 or 210 of at least two shields 206 in the module array are spaced apart by a distance D1 when at room temperature (e.g., 25° C.). Distance D1 as a non-overlap distance between adjacent shields 206 in the module array is shown in FIG. 4. That is, in the FIGS. 4 and 5 embodiment, the edges of adjacent shields in the module array do not overlap. In embodiments, distance D1 is substantially parallel to surface 101. The shields 206 of the module array in the FIGS. 4 and 5 embodiments can be described as non-overlapping, segmented shields or scales.

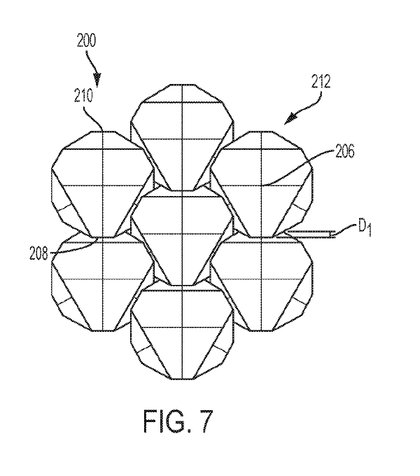

Distance D1 is an overlap distance between adjacent shields 206 in the module array is shown in FIGS. 6 and 7. That is, in the FIGS. 6 and 7 embodiments, the edges of adjacent shields in the module array overlap to form distance D1 between adjacent edges. The shields 206 of the module array in the FIGS. 6 and 7 embodiments can be described as overlapping, segmented shields or scales. Distance D1 may be from about 0.001 micron to about 10 mm, or from about 0.001 micron to about 5 mm, or even from about 0.1 mm to about 3 mm. In embodiments, distance D1 is measured substantially parallel to surface 101. In embodiments, the shield edges of at least 30% modules 201 in the array are spaced apart (by distance D1) from at least one adjacent module 201 shield 206 edge. In embodiments, as shown in FIG. 4 for example, the shield edges of all the modules 201 in the array are spaced apart (by distance D1) from all adjacent module shield edges in the array. Of course, thermal barrier 200 may include any combination of non-overlapping and overlapping edges spaced by distance D1 when at room temperature (i.e., when engine 100 is not in operation).

In the FIG. 4 embodiment, when edges 208, 210 of shields 206 in adjacent modules in the array do not overlap when at room temperature (i.e., distance D1 is a non-overlapping distance), distance D1 decreases to a distance D2 (not shown) when the internal combustion engine operates. Distance D1 is thus smaller than distance D2. That is, due to thermal expansion of adjacent shields 206 in the module array, distance D1 decreases to a distance D2 when the internal combustion engine operates (e.g., at a combustion gas temperature from about 1000° C. to about 3000° C. or more in the combustion chamber, at a piston temperature from about 100° C. to about 1000° C., when the internal temperature of the combustion chamber increases from room temperature to 100° C. or more). Distance D2 between edges of adjacent shields 206 when engine 100 operates is less than distance D1 between edges of adjacent shields 206 when engine 100 is not in operation (and at room temperature). In embodiments, distance D2 is from about 0 microns to about 10 mm, or from about 0 microns to about 1 mm, or even from about 0.001 micron to about 1 mm. In embodiments, distance D2 is configured to limit or eliminate penetration of combustion reactants or products through distance D2. In embodiments, distance D2 is configured to limit or eliminate the spalling of insulation material 204 out of vacant volume 205 through distance D2. In embodiments, edges 208, 210 of adjacent modules 201 in the module array may contact (i.e., distance D2 is 0) when engine 100 is in operation. Distance D2 can be configured considering the material of each shield 206 (and its CTE), the reaction temperature inside combustion chamber 102, and distance D1. Similarly, distance D1 may be determined during formation and placement of adjacent modules considering the material of each shield 206 (and its CTE) and the estimated surface temperature inside engine 100 so shield 206 edges form D2 or contact during engine operation.

In the FIGS. 6 and 7 embodiment, when edges 208, 210 of shields 206 of adjacent modules in the array overlap when at room temperature (i.e., distance D1 is an overlapping distance), distance D1 increases to a distance D3 (now shown) when the internal combustion engine operates. Distance D3 is thus larger than distance D1. That is, due to thermal expansion of adjacent shields 206 in the module array, distance D1 increases to a distance D3 when the internal combustion engine operates (e.g., at a gas temperature from about 1000° C. to about 3000° C. or more in the combustion chamber, at a piston temperature from about 100° C. to about 1000° C. (or about 100° C. to about 600° C.), when the internal temperature of the combustion chamber increases from room temperature to 100° C. or more). Distance D3 between edges of adjacent shields 206 when engine 100 operates is greater than distance D1 between edges of adjacent shields 206 when engine 100 is not in operation (and at room temperature). In embodiments, distance D3 is from about 0.001 micron to about 10 mm, or from about 0.001 micron to about 5 mm, or even from about 1 micron to about 5 mm. In embodiments, distance D3 is configured to further limit or eliminate penetration of combustion reactants or products through distance D3. In embodiments, distance D3 is configured to further limit or eliminate the spalling of insulation material 204 out of vacant volume 205 through distance D3. Distance D3 can be configured considering the material of each shield 206 (and its CTE), the reaction temperature inside combustion chamber 102, and distance D1.

In embodiments, shield 206 in each module is adjacent support 202 in said module. In embodiments, shield 206 joins directly or indirectly with support 202 in said module. Referring again to FIG. 4, each shield 206 may join directly to each support 202 in each module 201 at an end of support 202 spaced apart from surface 101. Shield 206 and support 202 in each module may be joined by metallic bonding, metal-to-metal bonding, or direct mechanical attachment. The connection between support 202 and shield 206 is configured to resist the combustion temperatures and pressures within combustion chamber 102 during operation of engine 100. For example, shield 206 may resist spalling of support 202 from surface 101 for ≥100,000 miles inside operating engine 100. Shield 206 may be applied to support 202 via 3-D printing, metallic plating, welding (arc, laser, plasma, or friction), brazing, plasma spraying, mechanical fastening, or other conventional methods of creating metallic bonding or metal-to-metal bonds. In other embodiments, shield 206 and support 202 may be integrally formed together such that bonding of individual pieces is not necessary.

In embodiments, support 202 and shield 206 of module 201 may be a metal element or a metal alloy commonly used in combustion chamber 102 manufacturing. The metal or metal alloy may include carbon steel, stainless steel, aluminum alloy, aluminum, nickel plated aluminum, titanium alloy, hastelloy, nickel based super alloy, cobalt-based super alloy, and combinations thereof, for example. The metal or metal alloy encompassing support 202 and shield 206 may also be other super alloys including nickel, chromium, cobalt, and combinations thereof. The metal or metal alloy of support 202 and shield 206 may have the same or different coefficient of thermal expansion (CTE) as the material encompassing surface 101 (assuming similar operating temperature ranges) to minimize thermal expansion stresses and failures at their connection. In an exemplary embodiment, the CTE of the metal or metal alloy of support 202 and shield 206 may be within 150% of the CTE as the material encompassing surface 101 (assuming similar operating temperature ranges). In yet another embodiment, the CTE of the metal or metal alloy of support 202 may be within 150% of the CTE of the metal or metal alloy of shield 206. In embodiments, at least one module 201 or thermal barrier 200 may have a CTE gradient from support 202 to shield 206.

In embodiments, thermal barrier 200 also includes a vacant volume 205. In embodiments, vacant volume 205 is defined at least partially between lower portion 214 of at least one shield 206 in the module array and surface 101. Referring to FIGS. 4 and 5, vacant volume 205 may be defined between surface 101 and the lower portions 214 of a plurality of shields 206 in the module array. In embodiments, vacant volume 205 is a tortuous volume around a plurality of supports 202 within the module array. In embodiments, vacant volume 205 may be a singular void space or a plurality of discrete and/or interconnected voids. In embodiments, vacant volume 205 extends across at least 50% of thickness T1, or substantially across thickness T1. In embodiments, the volumetric ratio of support 202 to vacant volume 205 along a length, width, and thickness T1 of thermal barrier 200 may be from about 3:1 to about 1:20, or from about 1:1 to about 1:5.

In embodiments, a cross-sectional area of all the shields 206 in the module array is greater than a cross-sectional area of all the supports 202 in the module array. As an example, shown in FIG. 5, the cross-sectional area of the shields 206 in the module array (shown along plane B-B substantially parallel to the combustion chamber surface) is greater than the cross-sectional area of all the supports 202 in the module array (shown along plane A-A substantially parallel to the combustion chamber surface). In embodiments, the module array includes a repeating structural pattern. As shown in FIGS. 4-7, thermal barrier 200 includes a repeating pattern via the plurality of modules 201 organized in a specific configuration. In embodiments, thermal barrier 200 may be non-repeating or discontinuous on surface 101 and localized to “hot spots” within the combustion chamber.

In embodiments, shield 206 upper portion 212 of one module is contiguous shield 206 lower portion 214 of an adjacent module. FIGS. 6 and 7 provide an example (with overlapping edges separated by distance D1 or distance D3, depending on the engine temperature) where upper portion 212 of one shield 206 in the module array is contiguous or adjacent the lower portion 214 of a second shield 206 in the module array. In embodiments, one or more shields 206 in the module array include an edge 208, 210 with a bevel adjacent upper portion 212 (illustrated as beveled edge 220 in FIG. 6). In embodiments, one or more shields 206 in the module array include an edge 208, 210 with a bevel adjacent lower portion 214. Of course, one or more modules may include a combination of beveled edges adjacent upper portion 212 and lower portion 214. Beveled edges along the upper portion 212 and/or the lower portion 214 of adjacent modules (as shown for example in FIGS. 6 and 7) may allow the increase in distance (from distance D1 to distance D3) between adjacent modules in the module array during operation of the engine. That is, opposing beveled edges between adjacent modules may substantially seal surface 101 from exposure to the combustion reaction during operation of engine 100. In embodiments, a beveled edge may include an edge at an angle less than 90 degrees with respect to upper portion 212 or lower portion 214.

In embodiments, thermal barrier 200 includes an insulation material 204. In embodiments, insulation material 204 is contained with vacant volume 205 between shield 206 and surface 101. That is, vacant volume 205 is at least partially filled with insulation material 204. Thus, a portion of vacant volume 205 is occupied (or eliminated) by the presence of insulation material 204 therein. Insulation material 204 may fill from 5% to 99% of vacant volume 205. In exemplary embodiments, insulation material 204 fills vacant volume 205. Referring back to FIG. 5, insulation material 204 (shown as a cross-hatched area) is contained within vacant volume 205. In embodiments, insulation material 204 may be configured between shield 206 and surface 101 to fortify at least one shield 206 in the module array and prevent collapsing/deforming due to the pressure of the combustion reaction. That is, insulation material 204 may mechanically support at least one shield 206 during operation of the engine. In embodiments, the volumetric ratio of support 202 to insulation material 204 along a length, width, and thickness T1 in thermal barrier 200 may be from about 1:1 to about 1:5. In embodiments, insulation material 204 has a density gradient along thickness T1 of support 202. The volumetric ratio, density, and location of insulation material 204 may allow for “tuning” of thermal barrier 200 to achieve a desired thermal conductivity.

In an exemplary embodiment, insulation material 204 is interlocked within thickness T1 (between shields 206 and surface 101) such that it does not escape, spall, or flake out from vacant volume 205 into combustion chamber 102 during operation of engine 100. In embodiments, surface 101 and/or lower portion 214 of at least one shield 206 in the module array may be corrugated to prevent movement (via skin friction) or loss of insulation material 204 into combustion chamber 102 during operation of engine 100.

Insulation material 204 may be air, a ceramic material, and/or combinations thereof. In embodiments, insulation material 204 is any material that is capable of flowing into or being contained within vacant volume 205 and with a thermal conductivity from about 0.1 W/m·K to about 12.0 W/m·K at 400° C., or from about 0.1 W/m·K to about 8.0 W/m·K at 400° C., or even from about 1.0 W/m·K to about 4.0 W/m·K at 400° C. Insulation material 204 is a composition having a thermal conductivity lower than surface 101 within vacant volume 205 to increase the thermal resistivity of thermal barrier 200 such that more energy of combustion is available for performing work and powering engine 100.

In an embodiment where insulation material 204 includes ceramic material, the ceramic material may have a porosity from about 10% to about 90%, or from about 30% to about 70%. The pores of the ceramic material may include air. Example ceramic materials include, but are not limited to, yttria stabilized zirconia (YSZ), zirconium dioxide, lanthanum zirconate, gadolinium zirconate, lanthanum magnesium hexaaluminate, gadolinium magnesium hexaaluminate, lanthanum-lithium hexaaluminate, barium zirconate, strontium zirconate, calcium zirconate, sodium zirconium phosphate, mullite, aluminum oxide, cerium oxide, and combinations thereof. The ceramic material of exemplary embodiments may be ceramic foam. The ceramic material of exemplary embodiments may also be formed from aluminates, zirconates, silicates, titanates, and combinations thereof.

In embodiments, the total thickness of thermal barrier 200 (thickness T1+thickness T2) is from about 0.1 mm to about 10 mm, or from about 0.1 mm to about 5 mm. In an exemplary embodiment, thermal barrier 200 has a thermal conductivity of about 0.1 W/m·K to about 12 W/m·K at 400° C., or about 1 W/m·K to about 5 W/m·K at 400° C. Various embodiments of composite thermal barrier 200 on a surface within engine 100 are provided in FIGS. 4-9. Of course, combinations of these embodiments and other embodiments are in accordance with this disclosure.

The present disclosure also includes methods of applying thermal barrier 200 to metallic surface 101 within combustion chamber 102 of engine 100. The method includes preparing metallic surface 101 for application of at least two supports 202. Preparing metallic surface 101 may include roughening, chemical etching, drilling, cleaning, or other processes of readying surface 101 for application of the plurality of supports 202 thereon. It is envisioned that the method of preparation of surface 101 will likely depend on the method of applying supports 202 on surface 101.

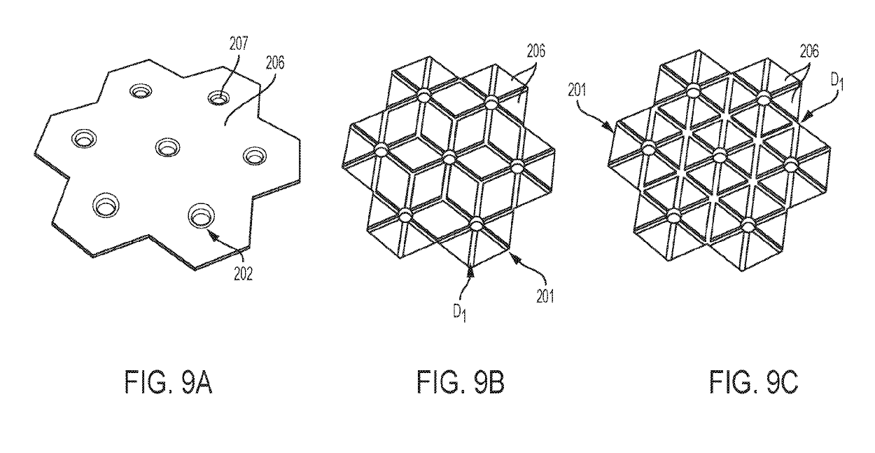

Methods of making thermal barrier 200 may include forming an array of modules 201. Methods of making thermal barrier 200 may include forming or joining a plurality of supports 202 on shield 206. Joining the plurality of supports 202 on shield 206 includes 3-D printing, metallic plating, mechanical fastening or threading, fusion welding, brazing, resistance welding, diffusion bonding, sintering, or other conventional methods of metallically bonding supports 202 to shield 206 via metal-to-metal bonds. In embodiments, as shown in FIG. 9A, supports 202 may be formed from a sheet metal to form thermal barrier 200. In this embodiment, supports 202 may be formed from shield 206 by sheet metal fabrication, punch forming, superplastic forming, hydroforming, chemical etching, electrical discharge machining, mechanical milling, pressing and sintering, and other similar processes. That is, shield 206 and supports 202 may be formed in one step from a single sheet of materials disclosed herein. In embodiments, supports 202 may be joined directly or indirectly to surface 101 before supports 202 are joined directly or indirectly to at least one shield 206.

Methods of making thermal barrier 200 may include removing a portion of shield 206 to create distance D1 between at least two of the module edges in the array. FIGS. 9B and 9C illustrate embodiments of the module array following removal of portions of shield 206 to form distance D1. In embodiments, FIGS. 9A-C may be a sequential process of forming the array of modules 201.

Methods of making thermal barrier 200 may include applying thermal barrier 200 to surface 101. Applying thermal barrier 200 to surface 101 includes joining directly or indirectly at least two supports 202 to surface 101. Applying thermal barrier 200 to surface 101 includes joining directly or indirectly a plurality of modules to surface 101. A support 200 may be joined to surface 101 via 3-D printing, metallic plating, mechanical fastening or threading, fusion welding, brazing, resistance welding, diffusion bonding, sintering, or other conventional methods of metallically bonding support 202 to surface 101 via metal-to-metal bonds. Methods of applying thermal barrier 200 to surface 101 may include the formation of vacant volume 205 around supports 202. Formation of vacant volume 205 may include etching, drilling, or any other process of metal removal.

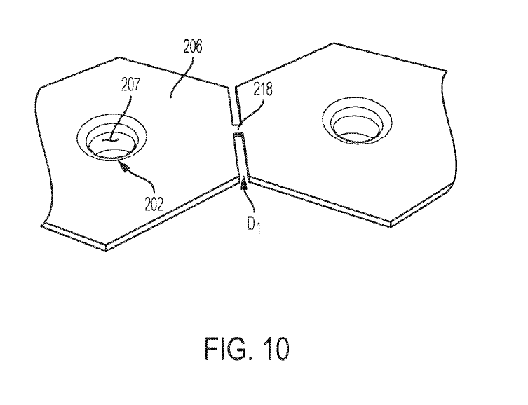

Methods of making thermal barrier 200 may also include removing at least a portion of one module 201 such that the outer edge of at least two module shields 206 are spaced apart by distance D1 when at room temperature. That is, removing at least a portion of shield 206 between two supports 202 to form distance D1 creates two separate modules 201. In embodiments, as shown in FIG. 10, a tab 218 may remain between adjacent modules to assist with applying the array of modules 201 to surface 101. Tab 218 extends only a fraction of the length between edges of adjacent modules 201. Methods of making thermal barrier 200 may include removing or breaking tabs 218 to form distance D1 across the entire length between adjacent modules. In the FIG. 10 embodiment, support 202 may be joined with surface 101 by heating methods applied through hollow portion 207 when support 202 contacts surface 101.

Methods of making thermal barrier 200 may also include inserting insulation material 204 within vacant volume 205. Methods of inserting insulation material 204 within vacant volume 205 may include pressure application, injection, pressing, impregnating, and other conventional methods of inserting a solid or gas insulator in vacant volume 205. It is envisioned that inserting insulation material 204 within vacant volume 205 may be accomplished while applying supports 202 to surface 101.

As used herein, the singular forms “a,” “an,” and “the” include plural referents unless the context clearly dictates otherwise. Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

1. A thermal barrier comprising:
an array of modules each comprising at least one support and a shield,
each module support in the array comprises a first end opposite a second end,
each module shield in the array comprises an edge and an upper portion opposite a lower portion,
the first end of each module support in the array joins directly or indirectly with the lower portion of at least one shield in the module array,
the second end of each support joins directly or indirectly with a surface within a combustion chamber of an internal combustion engine, and
the shield edges of at least two modules in the module array are spaced apart by a distance D1 when at about 25° C.

2. The thermal barrier of claim 1 wherein the distance D1 decreases to a distance D2 when the internal combustion engine operates.

3. The thermal barrier of claim 2 wherein the distance D2 is from about 0 microns to about 1 mm.

4. The thermal barrier of claim 1 wherein the distance D1 increases to a distance D3 when the internal combustion engine operates.

5. The thermal barrier of claim 4 wherein the distance D3 is from about 0.001 microns to about 5 mm.

6. The thermal barrier of claim 1 wherein the shield edges of at least 30% the modules in the array are spaced apart from at least one adjacent module shield edge.

7. The thermal barrier of claim 1 wherein the shield edges of all the modules in the array are spaced apart from all adjacent module shield edges in the array.

8. The thermal barrier of claim 1 wherein a cross-sectional area of all the shields in the module array is greater than a cross-sectional area of all the supports in the module array.

9. The thermal barrier of claim 1 further comprising a vacant volume between the shield of at least a module in the array and the combustion chamber surface.

10. The thermal barrier of claim 1 wherein a ratio of the volume of module array supports to the vacant volume is from 3:1 to 1:20.

11. The thermal barrier of claim 9 wherein the vacant volume is at least partially filled with an insulation material.

12. The thermal barrier of claim 11 wherein the insulation material is air, a ceramic material, or a combination thereof.

13. The thermal barrier of claim 12 wherein the ceramic material is yttria stabilized zirconia, zirconium dioxide, lanthanum zirconate, gadolinium zirconate, lanthanum magnesium hexaaluminate, gadolinium magnesium hexaaluminate, lanthanum-lithium hexaaluminate, barium zirconate, strontium zirconate, calcium zirconate, sodium zirconium phosphate, mullite, aluminum oxide, cerium oxide, or combinations thereof.

14. The thermal barrier of claim 1 further comprising a repeating structural pattern within the module array.

15. The thermal barrier of claim 1 further comprising a distance between the upper portion of each module shield in the array and the combustion chamber surface is from about 0.1 mm to about 5 mm.

16. The thermal barrier of claim 1 wherein at least one of the modules in the array includes a shield edge with a bevel adjacent the upper portion.

17. The thermal barrier of claim 1 wherein at least one of the modules in the array includes a support with a hollow portion therein.

18. The thermal barrier of claim 1 wherein the surface within a combustion chamber is at least one of: the top surface of a piston; a wall of a chamber compression volume; and a wall of a chamber exhaust volume.

19. A thermal barrier comprising:
at least two modules each comprising a support and a shield,
the module supports each comprising a first end opposite a second end,
the module shields each comprising an outer edge and a upper portion opposite a lower portion,
the first end of at least one of the module supports joins directly or indirectly with the lower portion of at least one of the two module shields,
the second end of the module supports join directly or indirectly with a surface within a combustion chamber of an internal combustion engine, and
the outer edges of the two module shields spaced apart by a distance D1 when at 25° C.

20. The thermal barrier of claim 19 wherein the distance D1 increases to a distance D3 when the at least two modules are at a temperature from about 100° C. to about 600° C.

21. The thermal barrier of claim 19 wherein the shield upper portion of one module is contiguous the shield lower portion of the second module.

22. The thermal barrier of claim 19 wherein the distance D1 decreases to a distance D2 when the at least two modules are at a temperature from about 100° C. to about 600° C.

23. The thermal barrier of claim 22 wherein the shield outer edge of one module contacts the shield outer edge of the second module.

24. The thermal barrier of claim 19 further comprising a plurality of the two modules as an array of modules.

25. The thermal barrier of claim 19, further comprising a volume between the shield lower portion of at least one module and the combustion chamber surface.

26. The thermal barrier of claim 25, wherein the volume contains an insulation material.

27. The thermal barrier of claim 19 wherein at least one of the module supports has a porosity from about 5% to about 90%.

28. The thermal barrier of claim 19 further comprising a distance between the upper portion of at least one module shield and the combustion chamber surface is from about 0.5 mm to about 5 mm.

29-32. (canceled)
